(19) United States
(12) Patent Application Publication
(10) Pub. No.: US 2026/0270321 A1
(43) Pub. Date: Sep. 10, 2026

(54) METHODS, SYSTEMS, AND COMPUTER READABLE MEDIA FOR SYNTHETIC MONITORING OF NETWORK FUNCTION (NF) SERVICE INSTANCES AND PROVIDING ENHANCED NF DISCOVERY USING NF REPOSITORY FUNCTION (NRF)

(71) Applicant: Oracle International Corporation, Redwood Shores, CA (US)

(72) Inventors: Virendra Singh, Bangalore (IN); Jay Rajput, Bangalore (IN); Shashikiran Bhalachandra Mahalank, Bangalore (IN)

(21) Appl. No.: 19/071,320

(22) Filed: Mar. 5, 2025

(51) Int. Cl. H04L 67/51; H04L 41/12

(52) U.S. Cl. CPC H04L 67/51; H04L 41/12

(57) ABSTRACT

A method for synthetic monitoring of NF service instances and providing for enhanced NF discovery using an NRF includes generating, by the NRF, synthetic monitoring request messages. The method further includes transmitting, by the NRF, the synthetic monitoring request messages to NF service instances registered with the NRF and receiving, from the NF service instances, responses to the synthetic monitoring request messages. The method further includes analyzing, by the NRF, contents of the responses to the synthetic monitoring request messages. The method further includes maintaining, by the NRF and based on the contents of the responses to the synthetic monitoring request messages, indications of working status of the NF service instances. The method further includes receiving, by the NRF, an NF discovery request message. The method further includes generating, by the NRF and using the indications of working status of the NF service instances, an NF discovery response message.

### TECHNICAL FIELD

The subject matter described herein relates to monitoring the status of NF service instances. More particularly, the subject matter described herein relates to methods, systems, and computer readable media for synthetic monitoring of NF service instances and providing enhanced NF discovery using an NRF.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that may occur in 5G and subsequent generation networks is that the NF service profile information available at the NRF may not reflect the current operational status of an NF service instance. For example, an NF service instance may be capable of heart-beating with the NRF so that the NRF maintains the current status of the NF service instance as available. However, the NF service instance may not be capable of forming error-free responses to service-based interface request messages, for example, due to a software error. As a result, when an NF seeks to discover the NF service profile of an NF service instance that is capable of heart-beating with the NRF but is not capable of properly responding to SBI requests, the NRF will include the NF service profile of the malfunctioning NF service instance in the NF discovery results, and the discovering NF may transmit an SBI request to the malfunctioning NF service instance, receive an erroneous response, and be forced to send the SBI request to an alternate NF service instance. Such a process is inefficient and can lead to call setup and other delays.

In light of these and other difficulties, there exists a need for improved methods, systems, and computer readable media for determining and maintaining status information of NF service instances at the NRF.

### SUMMARY

A method for synthetic monitoring of NF service instances and providing for enhanced NF discovery using an NRF includes generating, by the NRF, synthetic monitoring request messages. The method further includes transmitting, by the NRF, the synthetic monitoring request messages to NF service instances registered with the NRF and receiving, from the NF service instances, responses to the synthetic monitoring request messages. The method further includes analyzing, by the NRF, contents of the responses to the synthetic monitoring request messages. The method further includes maintaining, by the NRF and based on the contents of the responses to the synthetic monitoring request messages, indications of working status of the NF service instances. The method further includes receiving, by the NRF, an NF discovery request message. The method further includes generating, by the NRF and using the indications of working status of the NF service instances, an NF discovery response message.

According to another aspect of the subject matter described herein, generating the synthetic monitoring request messages includes generating the synthetic monitoring request messages addressed to different NF service instances associated with an NF instance.

According to another aspect of the subject matter described herein, generating the synthetic monitoring request messages includes generating synthetic service-based interface (SBI) request messages.

According to another aspect of the subject matter described herein, analyzing contents of responses to the synthetic monitoring request messages includes determining whether the responses to the synthetic SBI request messages include information elements (IEs) having expected values.

According to another aspect of the subject matter described herein, determining whether the IEs have expected values includes comparing values of the IEs in the responses to IE values in SBI response message templates.

According to another aspect of the subject matter described herein, maintaining the indications of working status of the NF service instances includes maintaining a status indication of unavailable for an NF service instance in response to determining that an IE in a response to one of the synthetic SBI request messages does not have an expected value.

According to another aspect of the subject matter described herein, maintaining the indications of working status of the NF service instances includes maintaining a status indication of available for an NF service instance in response to determining that the IEs in a response to one of the synthetic SBI request messages have expected values.

According to another aspect of the subject matter described herein, the method of synthetic monitoring of NF service instances and providing for enhanced NF discovery using an NRF includes maintaining, by the NRF, indications of latency of the NF service instances in responding to the synthetic monitoring request messages.

According to another aspect of the subject matter described herein, generating the NF discovery response message comprises, excluding, from the NF discovery response message, NF service profiles of NF service instances having an indication of working status of unavailable.

According to another aspect of the subject matter described herein, the method for synthetic monitoring of NF service instances and providing for enhanced NF discovery using an NRF includes transmitting, by the NRF and to a consumer NF or service communication proxy (SCP), the NF discovery response message.

According to another aspect of the subject matter described herein, a system for synthetic monitoring of NF service instances and providing for enhanced NF discovery using an NRF is provided. The system includes an NRF including at least one processor and a memory. The system further includes an NF topology manager implemented by the at least one processor for generating synthetic monitoring request messages, transmitting the synthetic monitoring request messages to NF service instances registered with the NRF, receiving, from the NF service instances, responses to the synthetic monitoring request messages, analyzing, contents of the responses to the synthetic monitoring request messages, maintaining, based on the contents of the responses to the synthetic monitoring request messages, indications of working status of the NF service instances, receiving an NF discovery request message, and generating, using the indications of working status of the NF service instances, an NF discovery response message.

According to another aspect of the subject matter described herein, the NF topology manager is configured to generate the synthetic monitoring request messages addressed to different NF service instances associated with an NF instance.

According to another aspect of the subject matter described herein, the synthetic monitoring request messages comprise synthetic SBI request messages.

According to another aspect of the subject matter described herein, the NF topology manager is configured to analyze contents of responses to the synthetic monitoring request messages by determining whether the responses to the synthetic SBI request messages include IEs having expected values.

According to another aspect of the subject matter described herein, the NF topology manager is configured to determine whether the responses to the synthetic SBI request messages include IEs having expected values by comparing values of the IEs in the responses to IE values in SBI response message templates.

According to another aspect of the subject matter described herein, the NF topology manager is configured to maintain the indications of working status of the NF service instances by maintaining a status indication of unavailable for an NF service instance in response to determining that an IE in a response to one of the synthetic SBI request messages does not have an expected value.

According to another aspect of the subject matter described herein, the NF topology manager is configured to maintain the indications of working status of the NF service instances by maintaining a status indication of available for an NF service instance in response to determining that the IEs in a response to one of the synthetic SBI request messages have expected values.

According to another aspect of the subject matter described herein, the NF topology manager is configured to maintain indications of latency of the NF service instances in responding to the synthetic monitoring request messages.

According to another aspect of the subject matter described herein, the NF topology manager is configured to exclude, from the NF discovery response message, NF service profiles of NF service instances having an indication of working status of unavailable.

According to another aspect of the subject matter described herein, a non-transitory computer readable medium having stored thereon executable instructions that when executed by a processor of a computer control the computer to perform steps is provided. The steps include generating, by an NRF, synthetic monitoring request messages. The steps further include transmitting, by the NRF, the synthetic monitoring request messages to NF service instances registered with the NRF. The steps further include receiving, by the NRF and from the NF service instances, responses to the synthetic monitoring request messages. The steps further include analyzing, by the NRF, contents of the responses to the synthetic monitoring request messages. The steps further include maintaining, by the NRF and based on the contents of the responses to the synthetic monitoring request messages, indications of working status of the NF service instances. The steps further include receiving, by the NRF, an NF discovery request message. The steps further include generating, by the NRF and using the indications of working status of the NF service instances, an NF discovery response message.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating NF discovery, NF selection, and forwarding of an SBI request message to an Nudm_UEContextManagement (Nudm_UECM) service instance provided by a UDM;

FIG. 3 is a message flow diagram illustrating NF discovery, NF selection, and the forwarding of an SBI request message to an Nudm_UECM service instance provided by a UDM where the Nudm_UECM service instance generates a malformed or incorrect information element in the SBI response message;

FIG. 4 is a message flow diagram illustrating the use of synthetic monitoring by the NRF to monitor the status of NF service instances and the use of results of the synthetic monitoring to formulate an NF discovery response message;

FIG. 5 is a flow chart illustrating an exemplary process performed by the NRF for using synthetic monitoring to monitor the status of NF service instances and to update an NF topology database;

FIG. 6 is a block diagram illustrating an exemplary architecture of an NRF for performing synthetic monitoring of NF service instances and using results of the synthetic monitoring to respond to NF discovery requests; and

FIG. 7 is a flow chart illustrating an exemplary process for performing synthetic monitoring of NF service instances by the NRF and using results of the synthetic monitoring to respond to NF discovery requests.

### DETAILED DESCRIPTION

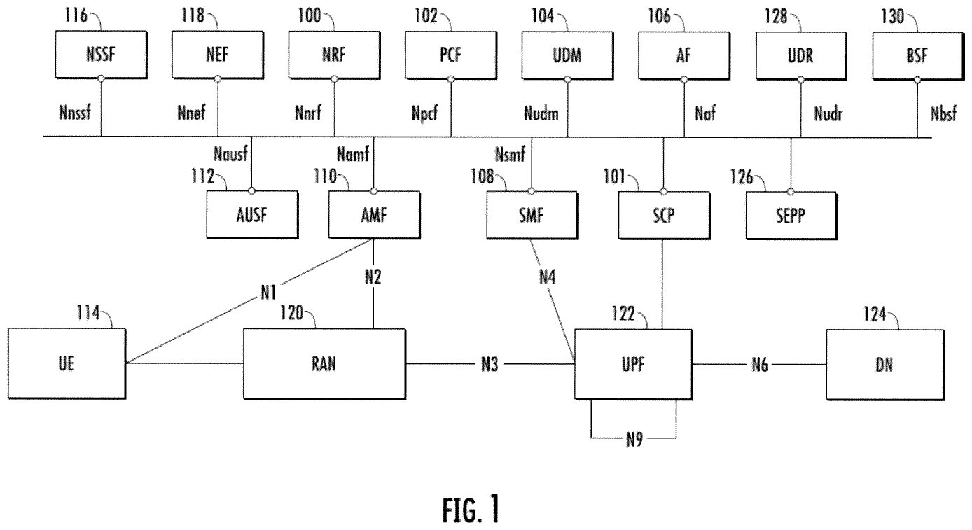

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A unified data repository (UDR) 128 stores subscription data for UEs. A binding support function (BSF) 130 manages bindings between PDU sessions and PCFs.

As stated above, one problem that can occur in 5G and subsequent generation networks is inefficiency in NF discovery and SBI request message processing because of stale or insufficiently fine-grained NF service instance status information at the NRF. The NRF is one of the key network functions of the 3GPP service-based architecture (SBA) for 5G core networks, acting as a central services discovery broker for NFs in the 5G core network. The NRF allows 5GC NFs to register, subscribe, discover and get access tokens using the NRF's service APIs, i.e., Nnrf_NFManagement, Nnrf_NFDiscovery and Nnrf_AccessToken (OAuth2 Authorization) services. For any 5G SBI communication to a producer NF, the consumer NF or SCP discovers the producer NF by sending an NF discovery service request to the NRF. The NRF uses the NF information available at the NRF for processing of a received NF discovery request from the consumer NF or SCP and generates and sends an NF discovery response to the consumer NF or SCP. The consumer NF or SCP then performs producer NF selection based on available producer NFs identified in the NF discovery response received from the NRF.

Producer NF service instances report their health status to the NRF, and health status computation is implementation-specific. For example, the health status information may be based on load/capacity parameters, such as central processing unit (CPU) utilization, memory utilization, or transactions per second (TPS). The health status reported by NF service instances may not include indications of the working status of service operations of NF service instances. For example, the utilization metrics reported by NF service instances may not include or consider whether an NF service instance is functioning as per expectations or whether the NF service instance has internal software errors (e.g., software bugs, incorrect NF service configuration, database corruption, faulty implementation behaviors of software, etc.)

NF service health status of individual producer NF service instances can be reported by the producer NF service instances in voluntary health status updates from the respective producer NF service instances. For example, producer NF service instances may report health status information using the NF update service operation to the NRF, e.g., using NF heart-beat request messages. In another example, producer NF service instances may report health status information directly to consumer NF instances using overload control information (OCI)/load control information (LCI) headers in service responses to the consumer NF service instances.

There is no validation available for producer NF service instance working behavior by cross verifying the header and IE level content of SBI response messages (e.g., NF producer service instances may behave differently due to different software versions, incorrect configuration, software bugs, etc.) As a result, there is a need to validate the working behavior of a producer NF service instance before selecting the producer NF service instance for forwarding/routing of 5G SBI service requests to avoid service outages or impacts to end mobile subscriber 5G services due to incorrect behavior of specific producer NF service instances of 5G core networks. It is also desirable to increase the likelihood of optimized producer NF selection and more successful processing of SBI messages for different end-to-end service procedures.

The subject matter described herein includes synthetic monitoring (of 5GC producer NF service instances), which produces fine-grained and updated producer NF service instance status information at the NRF and improved NF discovery results, which leads to more efficient producer NF service instance selection by NF service consumers. Improved producer NF service instance selection leads to an increased likelihood of successful processing of SBI request messages and a reduced likelihood of service outages or impacts to end mobile subscriber 5G services due to incorrect behavior of specific producer NF service instances of the 5G core network.

The NRF offers services for 5GC NFs to register, subscribe, discover and obtain access tokens. For example, the Nnrf_NFManagement service enables NFs to register their NF profiles with the NRF, update their NF profiles with the NRF, and subscribe to be notified of updates in NF profiles of other NFs at the NRF. The Nnrf_NFDiscovery service allows an NF or SCP instance to discover other NF instances and the potential services offered by the NF instance or to discover SEPP instances in the same PLMN as the discovering NF or SCP.

The Nnrf_AccessToken (OAuth2 Authorization) service is used for OAuth2 authorization, following the “Client Credentials” authorization grant, as specified in 3GPP TS 33.501. The Nnrf_AccessToken service exposes a “Token Endpoint” where the access token request service can be requested by NF service consumers.

For any 5G SBI communication to a producer NF, a consumer NF/SCP first discovers producer NFs by sending an NF discovery service request to the NRF. The NRF uses the NF information available at the NRF for processing of a received NF discovery request from a consumer NF and generates and sends an NF discovery response to the consumer NF or SCP. The consumer NF or SCP then performs producer NF selection based on available producer NFs identified in the NF discovery response received from the NRF. It should be noted that producer NF selection is entirely based on the available NF information in NF discovery response from Nnrf_NFDiscovery service of the NRF. As a result, inaccurate or incomplete producer NF status information maintained by the NRF can lead to inefficiency in NF selection.

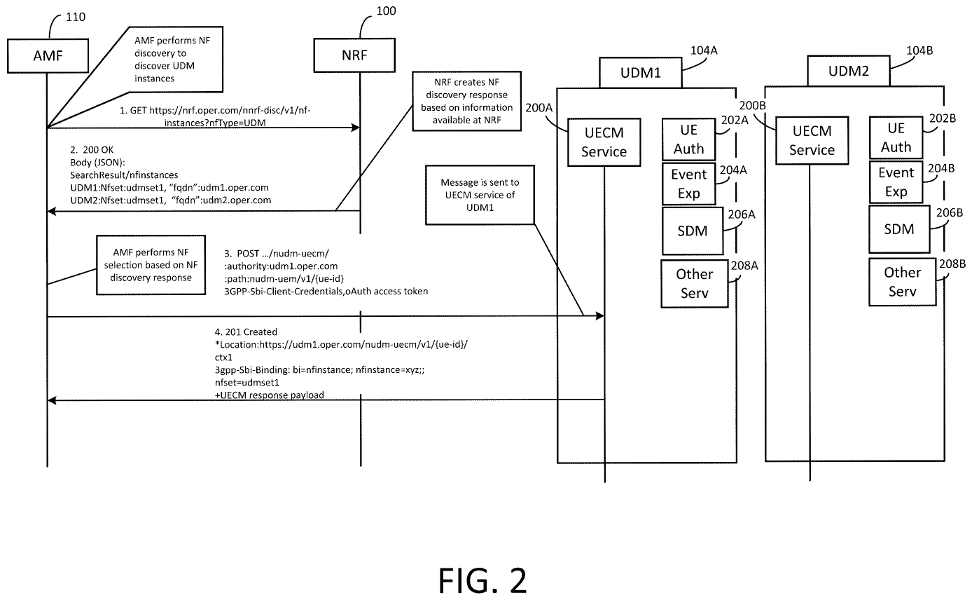

FIG. 2 is a message flow diagram illustrating the use of NF discovery information from an NRF to select an NF service instance and subsequent forwarding of the SBI request to the selected NF service instance. In FIG. 2, the service needed by the requesting NF is the Nuecm service provided by a UECM service instance of a UDM instance. Referring to the message flow in FIG. 2, an AMF 110, in step 1, performs NF discovery with NRF 100 to obtain NF profiles of UDM instances. NRF 100 receives the NF discovery request, searches its NF topology database for available UDM instances, and, in step 2, generates and sends an NF discovery response. The NF discovery response includes the NF profiles of UDM1 104A and UDM2 104B. UDM1 104A includes UECM service instance 200A, UE authentication service instance 202A, event exposure service instance 204A, and other service instances 208A. Similarly, UDM2 104B includes UECM service instance 200B, UE authentication service instance 202B, event exposure service instance 204B, and other service instances 208B.

AMF 110 receives the NF discovery response and selects, from the NF discovery response, UECM service instance 200A. In step 3, AMF 110 sends an Nudm_UECM request message to UECM service instance 200A to access the Nudm_UECM service. In step 4, Nudm_UECM service instance 104A responds to the Nudm_UECM request by generating and sending an Nudm_UECM response message to AMF 110. In this example, it is assumed that the Nudm_UECM response message includes all of the proper information elements.

Thus, there is no NF service discovery or NF selection inefficiency illustrated in FIG. 2 because Nudm_UECM service instance 104A is available and properly processes the Nudm_UECM service request. However, inefficient NF discovery and NF selection will occur if the status of an NF service producer maintained by NRF 100 is not up to date and/or insufficiently fine-grained.

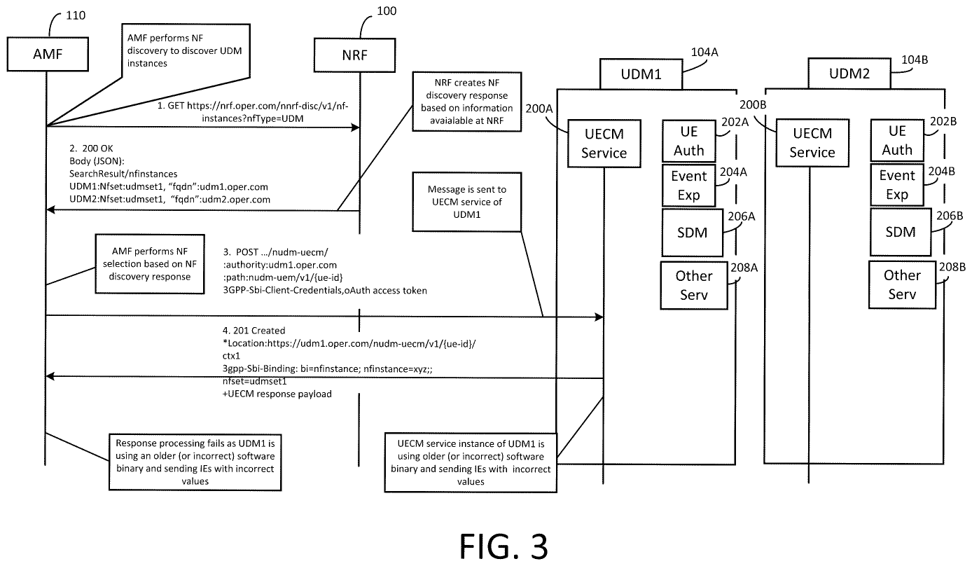

FIG. 3 is a message flow diagram illustrating the use of NF discovery information from an NRF to select an NF service instance and subsequent forwarding of the SBI request to the NF service instance where the NF service instance generates a malformed or incorrect information element in the SBI response message. Referring to FIG. 3, in step 1, AMF 110 performs NF discovery with NRF 100 to obtain NF profiles of UDM instances. NRF 100 receives the NF discovery request, searches its NF profiles database for available UDM instances, and, in step 2, generates and sends an NF discovery response. The NF discovery response includes the NF profiles of UDM1 104A and UDM2 104B, including the NF service profiles of all of the NF service instances associated with UDM1 104A and UDM2 104B.

AMF 110 receives the NF discovery response and selects, from the NF discovery response, UECM service instance 200A. In step 3, AMF 110 sends an Nudm_UECM request message to UECM service instance 200A to access the Nudm_UECM service. In step 4, Nudm_UECM service instance 104A responds to the Nudm_UECM request by generating and sending an Nudm_UECM response message to AMF 100.

In the example illustrated in FIG. 3, Nudm_UECM service instance 104A is using an incorrect or out of date software version and, as a result, generates responses with incorrect IEs. Accordingly, in step 5, Nudm_UECM service instance 200A responds to the Nudm_UECM request by generating and sending an Nudm_UECM response message with incorrect IEs to AMF 110. AMF 110 receives the Nudm_UECM response message, detects the incorrect IEs in the response message, and is required to repeat the steps illustrated in FIG. 3 to obtain the Nudm_UECM service from an alternate producer NF, such as UDM2 104B.

To avoid or reduce the likelihood of the scenario illustrated in FIG. 3, the NRF described herein periodically performs synthetic monitoring to obtain up to date and fine-grained health information from producer NF service instances and uses the health information to respond to NF discovery requests. In performing the synthetic monitoring, the NRF simulates real consumer NF service instances and generates and sends periodic synthetic monitoring request messages to NF service instances registered with the NRF. In one example, the synthetic monitoring request messages are synthetic SBI request messages. The NRF may utilize preconstructed SBI request message templates with header and IE values of SBI request messages for each of the service operations of the different SBI interfaces of producer NF instances that are registered with the NRF. Using the network illustrated in FIG. 3 as an example, NRF 100 may generate different synthetic SBI request messages to test the Nudm_UECM service instances, the SDM service instances, the event exposure service instances, the UE authentication service instances, and the other service instances of UDMs 104A and 104B. An SBI request message template useable by NRF 100 to generate the synthetic Nudm_UECM service request message may include the following information elements:

TABLE 1
Nudm_UEContextManagement Request Message Template

| | | | | Client | |
|---|---|---|---|---|---|
| HTTP | | | | Creden- | Access |
| Method | Service Name | Authority | Path | tials | Token |
| PUT | Amf3GppAccessReg- | Authority | URL | Creden- | Access |
| | istration | for UDM | for NF | tials | Token |
| | | instance | service | | |
| | | | Instance | | |

In Table 1, the first row represents the information elements that would be included in the Nudm_UECM request message. The second row indicates the values of the IEs for the template. Because the UDM being tested is registered with NRF 100, NRF 100 may have access to the authority, URL, and access token values useable to request specific services from the UDM. NRF 100 may generate its own client credentials assertion header. If NRF 100 is pretending to be an actual consumer NF service instance that exists in the network, NRF 100 may use the client credentials received from the consumer NF and the access token issued to the consumer NF. NRF 100 will use these values to build a synthetic SBI request message to send to a specific Nudm_UECM service instance.

When NRF 100 receives a response message from the Nudm_UECM service instance, NRF 100 verifies the information elements in the response by comparing the values of the information elements to values in a corresponding SBI response message template. Table 2 shown below illustrates examples of information elements that may be included in an SBI response message template for the Nudm_UEContextManagement service.

TABLE 2
Nudm_UEContextManagement Response Message Template

| HTTP | | 3gpp-Sbi- |
|---|---|---|
| Method | Location | Binding |
| 200 OK | Expected | Binding |
| | Location for | indicator, |
| | Nudm_UECM | NF instance |
| | service from | Id, NFSet Id |
| | routing table | from routing |
| | entry | table entry |

In Table 2, the first row represents the information elements that would be included in the response message for an AMF registration message for 3GPP access, which is one example of a request that can be fulfilled by the Nudm_UEContextManagement service. The second row indicates the values of the IEs for the template. NRF 100 will use these values to validate the received SBI response message. For example, NRF 100 will verify that the HTTP method type of the response message is 200 OK, that the expected location in the location header corresponds to the location in the routing table entry, and that the NF instance ID and the NF set ID in the 3gpp-sbi-Binding header match the corresponding values in the routing table entry.

It should be noted that NRF 100 may, in addition to validating responses to individual SBI request messages, also validate SBI request messages in a set of SBI request messages that form an SBI transaction. For example, for the Nudm_UEContextManagement service, NRF 100 may validate a registration and deregistration transaction for the Nudm_UECM service. To initiate the validation, NRF 100 generates and sends a synthetic AMF registration for 3GPP access message to a Nudm_UECM service instance. After validating the registration portion of the transaction, NRF 100 may send a synthetic AMF deregistration for 3GPP access message to the Nudm_UECM service instance and verify that the AMF instance is successfully deregistered by the Nudm_UECM service instance.

In general, when NRF 100 creates a resource object, such as the registration resource object in the preceding example, on a producer NF service instance using synthetic monitoring, NRF 100 may also delete the resource object on the producer NF service instance. NRF 100 may delete the resource object once the result of the synthetic monitoring has been determined. NRF 100 may delete the resource object by sending an SBI request message to delete the resource object, such as the AMF deregistration for 3GPP access message in the preceding example.

NRF 100 generates synthetic SBI request messages for different producer NF services and periodically sends the SBI service request messages to the producer NF service instances. NRF 100 receives the responses from individual producer NF service instances and compares the responses to expected response messages stored by NRF 100 as templates. NRF 100 verifies each of the header and IE values of the response messages. If the message content matches the expected values, then the corresponding NF producer service instance is marked as a healthy candidate for NF selection, and the NF or service profile of the NF producer service instance will be included in NF discovery response messages. If the response message is not received or does not include the correct IE values, the NRF considers the NF producer service instance as unhealthy and removes the producer NF service instance as a candidate for inclusion in NF discovery response messages until the NF producer service instance passes synthetic message validation. The NRF can also monitor latency of synthetic responses to determine the efficiency of NF producer service instances and, based on the latency, whether to include the NF service profiles of the NF producer service instances in NF discovery response messages.

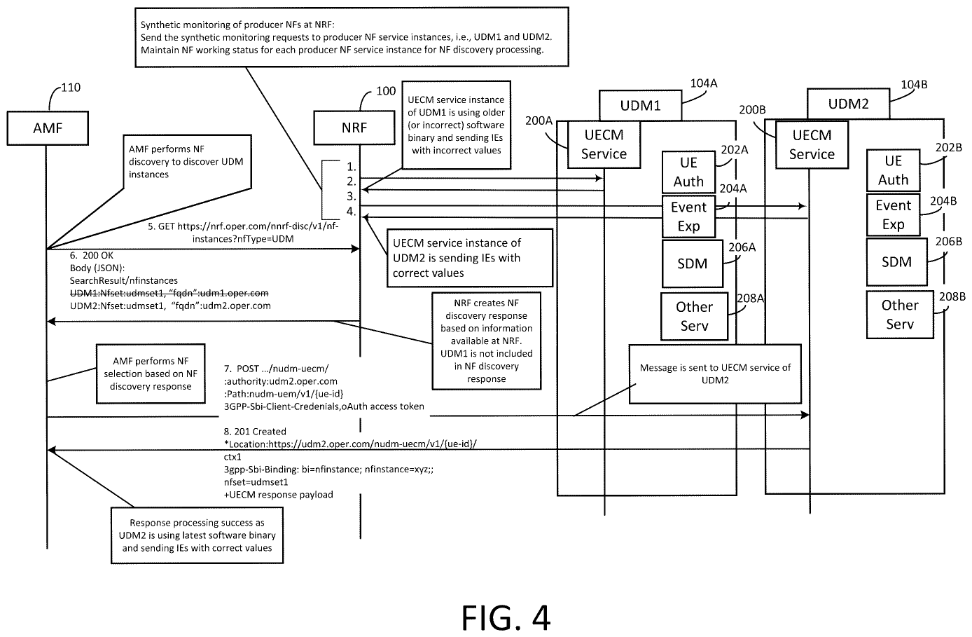

FIG. 4 is a message flow diagram illustrating the use of synthetic monitoring to monitor the status of NF service instances and the use of results of the synthetic monitoring to respond to NF discovery request messages. Referring to FIG. 4, in step 1, NRF 100 generates and sends a synthetic SBI request message to Nudm_UECM service instance 200A. In step 2, Nudm_UECM service instance 200B returns an SBI response message with information elements having expected values. NRF 100 thus marks the working status of UECM service instance 200A as available.

In step 3, NRF 100 generates and sends a synthetic SBI request message to Nudm_UECM service instance 200A. In step 4, Nudm_UECM service instance 200A returns an SBI response message with one or more IEs that do not have expected values. NRF 100 determines that the response is invalid by comparing the values of the IEs in the response message to expected values in a corresponding response template and determining that the values do not match. Accordingly, NRF 100 stores an indication of “unavailable” as the working status for UECM service instance 200A. It is important to note that NRF 100 may store the indication of “unavailable” as the working status for UECM service instance 200A even when UDM instance 104 and/or UECM service instance 200A is successfully heart-beating with NRF 100.

In step 5, AMF 110 performs NF discovery with NRF 100 to obtain NF profiles of UDM instances. NRF 100 receives the NF discovery request, searches its NF profiles database for available UDM instances, and, in step 6, generates and sends an NF discovery response. The NF discovery response includes the NF profile of UDM2 104B but not the NF profile of UDM1 104A because the working status of UDM1 104A maintained by NRF 100 indicates that UDM1 104A is unavailable.

In step 7, AMF 110 sends a non-synthetic SBI request message to Nudm_UECM service instance 200B. In step 8, Nudm_UECM service instance 200B returns a valid response message, thus avoiding the scenario illustrated in FIG. 3 where AMF 110 is required to re-initiate the request for Nudm_UECM service. NRF 100 may perform synthetic monitoring for all of the services illustrated in FIG. 4 and update the indications of working status of each NF service to reflect the status of each service.

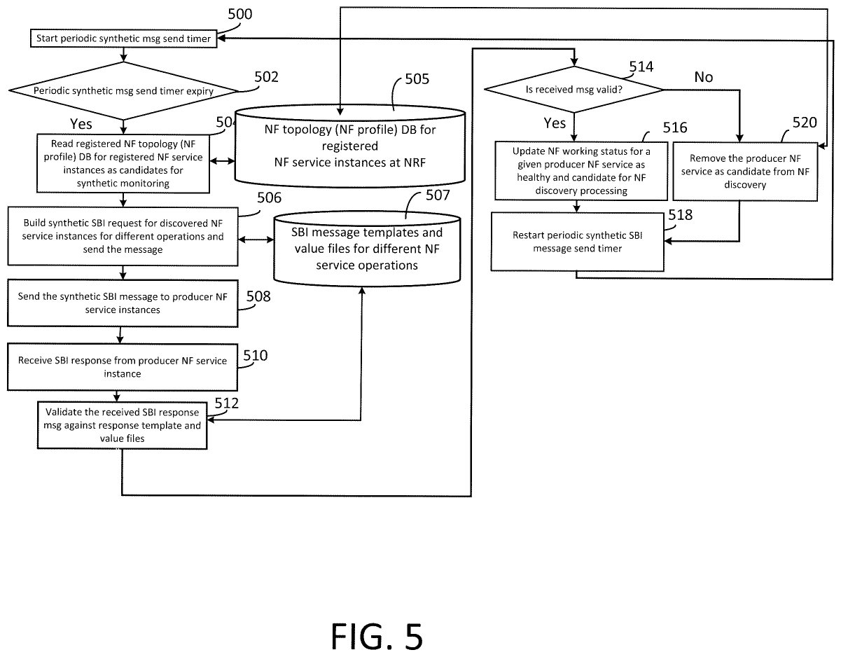

FIG. 5 is a flow chart illustrating an exemplary process performed by NRF 100 for using synthetic monitoring to monitor the status of NF service instances and to update working status information for NF service instances. Referring to FIG. 5, in step 500, NRF 100 starts a periodic synthetic message send timer. In step 502, NRF 100 detects expiration of the periodic synthetic message send timer. In step 504, NRF 100 reads its NF topology database 505 to identify registered NF service instances as candidates for synthetic monitoring. NF topology database 505 may store the NF profiles of NF instances registered with NRF 100. NF topology database 505 or a separate database may store an indication of the working status of each NF instance, which is determined based on results of the synthetic monitoring. NRF 100 may use NF topology database 505 to respond to NF discovery requests.

In step 506, NRF 100 builds synthetic SBI request messages for each registered NF service instance for different operations and sends the messages. NRF 100 may build the messages using SBI request message templates stored in synthetic SBI message templates database 507. Synthetic SBI message templates database 507 stores information elements and information element values for SBI request and response message types for services of NF service instances registered with NRF 100.

In step 508, NRF 100 sends the synthetic SBI request messages to the producer NF service instances. In step 510, NRF 100 receives an SBI response message from one of the producer NF service instances. In step 512, NRF 100 validates the received SBI response message against one of the SBI response message templates and value files stored in database 507.

In step 514, NRF 100 determines whether the received SBI message is valid. If the message is valid, control proceeds to step 516 where NRF 100 updates the working status information, for example, in NF topology database 505, for the producer NF service instance for which the response message was received to indicate that the service instance is healthy and a candidate to be included in an NF discovery response. Control then proceeds to step 518 where NRF 100 restarts the periodic synthetic SBI message send timer and then control returns to step 502 to repeat the synthetic monitoring process when the timer expires again.

Returning to step 514, if NRF 100 determines that a received SBI response message is invalid, control proceeds to step 520 where NRF 100 removes the service profile of the producer NF service instance as a candidate for inclusion in NF discovery responses. Control then proceeds to step 518 where the periodic synthetic SBI message send timer is restarted. NRF 100 then returns to step 502 to restart the synthetic monitoring process when the timer expires again. It should be noted that steps 510-518 may be performed for each SBI response message received in response to one of the synthetic SBI request messages transmitted in step 508.

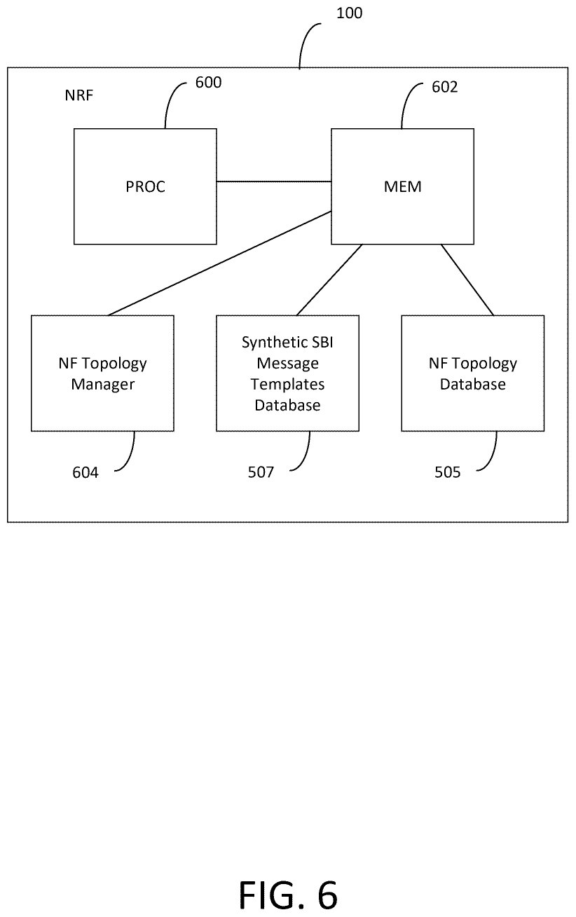

FIG. 6 is a block diagram illustrating an exemplary architecture of an NRF for performing synthetic monitoring and using the synthetic monitoring to update routing rules. Referring to FIG. 6, NRF 100 includes at least one processor 600 and memory 602. NRF 100 further includes NF topology database 505 including NF profiles of registered NF instances and the NF service profiles of service instances implemented by each of the registered NF instances. NF topology database 505 also includes, for each of the NF service profiles, an indication of working status of the NF service instance that indicates whether the NF service instance is available or not available. Table 3 shown below illustrates NF working status information that may be maintained by NRF 100 for the NF service instances illustrated in FIG. 4.

TABLE 3
NF Service Profile Information Stored by NRF

| NF Service Profile | Working Status Indication |
|---|---|
| UECM Service 200A | Unavailable |
| UE Auth Service 202A | Available |
| Event Exposure Service 204A | Available |
| SDM Service 206A | Available |
| Other UDM 104A Service Instances | Available |
| UECM Service 200B | Available |
| UE Auth Service 202B | Available |
| Event Exposure Service 204B | Available |
| SDM Service 206B | Available |
| Other UDM 104B Service Instances | Available |

In Table 3, NRF 100 maintains an indication of the working status of each individual service instance of NF instances registered with NRF 100. NRF 100, in responding to NF discovery requests, may include, in NF discovery responses, the service profile of any NF service instance of an NF instance whose NF profile has parameters that match query parameters in an NF discovery request and has a status of available. Using the data in Table 3 as an example, if an NF service consumer sends an NF discovery request having query parameters that indicate that UDM service is required, NRF 100 may respond with the NF service profiles of all of the NF service instances identified in Table 3 except for UECM service instance 200A.

NF topology database 505 may also be updated using OCI/LCI obtained from producer NFs in SBI response messages. The health status information stored in NF topology database 505 may also be updated using results obtained from synthetic monitoring as described herein. NRF 100 further includes synthetic SBI message templates database 507 that stores information for creating synthetic SBI request messages of various types and validating SBI response messages. NRF 100 further includes an NF topology manager 604 that performs the steps described herein for synthetic monitoring and updating of NF topology database 505 based on results of the synthetic monitoring. In one example, NF topology manager 604 may be implemented using computer executable instructions stored in memory 602 and executed by processor 600.

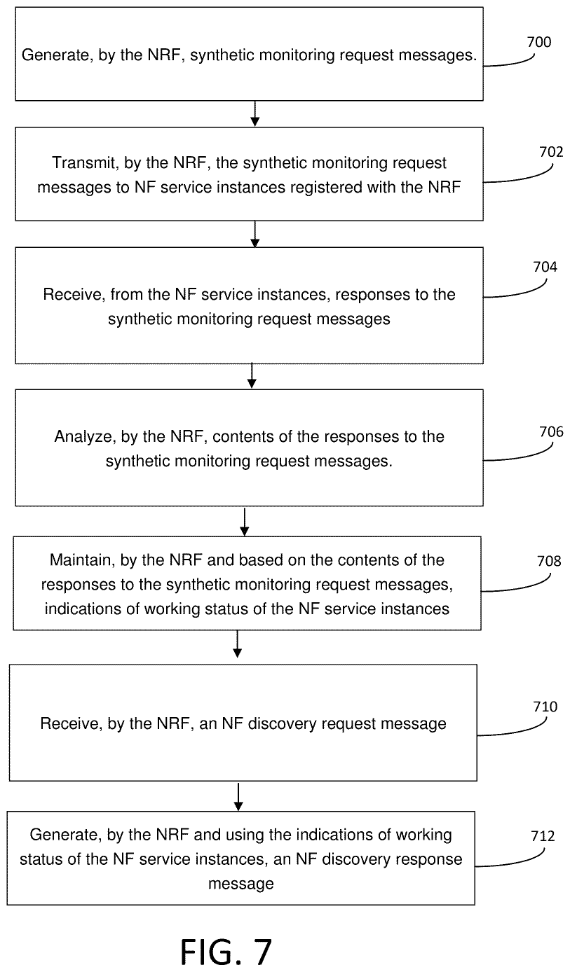

FIG. 7 is a flow chart illustrating an exemplary process for performing synthetic monitoring by the NRF and using results of the synthetic monitoring to intelligently respond to NF discovery requests. Referring to FIG. 7, in step 700, the process includes generating, by the NRF, synthetic monitoring request messages. For example, an NRF, such as NRF 100, may generate synthetic SBI request messages using message templates stored by NRF 100 for each NF service instance registered with NRF 100.

In step 702, the method further includes transmitting, by the NRF, the synthetic monitoring request messages to NF service instances registered with the NRF. For example, an NRF, such as NRF 100, may transmit the synthetic SBI request messages to the producer NF service instances registered with NRF 100.

In step 704, the process includes receiving, from the NF service instances, responses to the synthetic monitoring request messages. For example, an NRF, such as NRF 100 may receive SBI response messages in response to the synthetic SBI request messages.

In step 706, the process includes analyzing, by the NRF, contents of the responses to the synthetic monitoring request messages. For example, an NRF, such as NRF 100 may read the values of IEs contained in the SBI response messages and compare the values to expected values in SBI response message templates maintained by NRF 100.

In step 708, the process includes maintaining, by the NRF and based on the contents of the responses to the synthetic monitoring request messages, indications of working status of the NF service instances. For example, an NRF, such as NRF 100, may maintain a working status indication of each of the NF service instances, where the working status indication indicates whether or not the NF service instance is operating in accordance with expectations.

In step 710, the process includes receiving, by the NRF, an NF discovery request message. For example, an NRF, such as NRF 100, may receive an NF discovery request message from a consumer NF or an SCP.

In step 712, the process includes generating, by the NRF and using the indications of working status of the NF service instances, an NF discovery response message. For example, an NRF, such as NRF 100 may locate the NF profiles of NF instances that match query parameters in an NF discovery request message. NRF 100 may include, in the NF discovery response message, the NF profiles of NF instances whose services are working in accordance with expectations and exclude, from the NF discovery response, NF profiles of NF instances whose services are not working in accordance with expectations.

Exemplary advantages of the subject matter described herein include the ability to detect false health status of producer NF instance reported to the NRF by verifying the working behavior of producer NF service instance through synthetic messages without impacting the processing of real SBI request messages received from NF consumer service instances. Yet another advantage of the subject matter described herein is that the synthetic monitoring results provide for enhanced NF discovery request processing and enhanced producer NF selection. Another advantage of synthetic monitoring by the NRF as described herein is that synthetic monitoring validates the compliance of behavior of individual producer NF service instances by verifying the individual IE values of SBI response messages for different NF producer service instances. Yet another advantage of synthetic monitoring by the NRF as described herein is that performing the synthetic monitoring at the NRF avoids or reduces the impact on end 5G services by early detection of incorrect behavior of producer NF service instances. Yet another advantage of synthetic monitoring by the NRF is that it reduces the need for NF consumer instances to validate producer NF service instance behavior. Yet another advantage of synthetic monitoring is that it reduces the need for re-initiation of end to end 5G service procedures due to incorrect responses of specific producer NF services and hence improves overall network efficiency of 5G core network service procedures.

Performing synthetic monitoring at the NRF is believed to be particularly advantageous because the NRF operates as a central services discovery broker for all NFs in the 5G core network. Being the central services discovery broker for NFs makes the NRF a desirable candidate to perform validation of the working behavior of the 5G producer NF service instances. Performing synthetic validation at the NRF before 5GC producer NF discovery and NF selection for 5G SBI service request routing is also advantageous because errors are detected early in the call or session setup process. The synthetic monitoring performed by the NRF as described herein is agnostic to SCP deployment in the 5GC network and functions in networks both with and without SCPs.

In summary, the subject matter described herein enables enhanced NF discovery and producer NF selection using synthetic monitoring by the NRF in conjunction with other NRF-based NF information. The enhanced NF discovery results may be used by NF service consumers to select producer NF service instances that are more likely to be available and functioning properly than without synthetic monitoring by the NRF. Selecting a producer NF service instance whose operational status has been verified by the NRF increases the likelihood of successful processing of SBI messages for different end-to-end 5G service procedures. As a result, the likelihood of service outages and impacts to end mobile subscriber 5G services due to incorrect behavior of specific producer NF service instances of the 5G core network is decreased.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.1.0 (2024-12)
2. 3^{rd} Generation Partnership Project; Technical Specification Group Services and System Aspects; Procedures for the 5G System (5GS); Stage 2 (Release 19) 3GPP TS 23.502 V19.2.0 (2024-12)
3 3^{rd} Generation Partnership Project; Technical Specification Group Core Network and Terminals; 5G System; Technical Realization of Service Based Architecture; Stage 3 (Release 19) 3GPP TS 29.500 V19.1.0 (2024-12)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A method for synthetic monitoring of network function (NF) service instances and providing for enhanced NF discovery using an NF repository function (NRF), the method comprising:
generating, by the NRF, synthetic monitoring request messages;
transmitting, by the NRF, the synthetic monitoring request messages to NF service instances registered with the NRF;
receiving, by the NRF and from the NF service instances, responses to the synthetic monitoring request messages;
analyzing, by the NRF, contents of the responses to the synthetic monitoring request messages;
maintaining, by the NRF and based on the contents of the responses to the synthetic monitoring request messages, indications of working status of the NF service instances;
receiving, by the NRF, an NF discovery request message; and
generating, by the NRF and using the indications of working status of the NF service instances, an NF discovery response message.

2. The method of claim 1 wherein generating the synthetic monitoring request messages includes generating the synthetic monitoring request messages addressed to different NF service instances associated with an NF instance.

3. The method of claim 1 wherein generating the synthetic monitoring request messages includes generating synthetic service-based interface (SBI) request messages.

4. The method of claim 3 wherein analyzing contents of responses to the synthetic monitoring request messages includes determining whether the responses to the synthetic SBI request messages include information elements (IEs) having expected values.

5. The method of claim 4 wherein determining whether the IEs have expected values includes comparing values of the IEs in the responses to IE values in SBI response message templates.

6. The method of claim 4 wherein maintaining the indications of working status of the NF service instances includes maintaining a status indication of unavailable for an NF service instance in response to determining that an IE in a response to one of the synthetic SBI request messages does not have an expected value.

7. The method of claim 4 wherein maintaining the indications of working status of the NF service instances includes maintaining a status indication of available for an NF service instance in response to determining that the IEs in a response to one of the synthetic SBI request messages have expected values.

8. The method of claim 1 comprising maintaining, by the NRF, indications of latency of the NF service instances in responding to the synthetic monitoring request messages.

9. The method of claim 1 wherein generating the NF discovery response message comprises, excluding, from the NF discovery response message, NF service profiles of NF service instances having an indication of working status of unavailable.

10. The method of claim 1 comprising transmitting, by the NRF and to a consumer NF or service communication proxy (SCP), the NF discovery response message.

11. A system for synthetic monitoring of network function (NF) service instances and providing for enhanced NF discovery using an NF repository function (NRF), the system comprising:
an NRF including at least one processor and a memory; and
an NF topology manager implemented by the at least one processor for generating synthetic monitoring request messages, transmitting the synthetic monitoring request messages to NF service instances registered with the NRF, receiving, from the NF service instances, responses to the synthetic monitoring request messages, analyzing contents of the responses to the synthetic monitoring request messages, maintaining, based on the contents of the responses to the synthetic monitoring request messages, indications of working status of the NF service instances, receiving an NF discovery request message, and generating, using the indications of working status of the NF service instances, an NF discovery response message.

12. The system of claim 11 wherein the NF topology manager is configured to generate the synthetic monitoring request messages addressed to different NF service instances associated with an NF instance.

13. The system of claim 11 wherein the synthetic monitoring request messages comprise synthetic service-based interface (SBI) request messages.

14. The system of claim 13 wherein the NF topology manager is configured to analyze contents of responses to the synthetic monitoring request messages by determining whether the responses to the synthetic SBI request messages include information elements (IEs) having expected values.

15. The system of claim 14 wherein the NF topology manager is configured to determine whether the responses to the synthetic SBI request messages include IEs having expected values by comparing values of the IEs in the responses to IE values in SBI response message templates.

16. The system of claim 14 wherein the NF topology manager is configured to maintain the indications of working status of the NF service instances by maintaining a status indication of unavailable for an NF service instance in response to determining that an IE in a response to one of the synthetic SBI request messages does not have an expected value.

17. The system of claim 14 wherein the NF topology manager is configured to maintain the indications of working status of the NF service instances by maintaining a status indication of available for an NF service instance in response to determining that the IEs in a response to one of the synthetic SBI request messages have expected values.

18. The system of claim 11 wherein the NF topology manager is configured to maintain indications of latency of the NF service instances in responding to the synthetic monitoring request messages.

19. The system of claim 11 wherein the NF topology manager is configured to exclude, from the NF discovery response message, NF service profiles of NF service instances having an indication of working status of unavailable.

20. A non-transitory computer readable medium having stored thereon executable instructions that when executed by a processor of a computer control the computer to perform steps comprising:
generating, by a network function (NF) repository function (NRF), synthetic monitoring request messages;
transmitting, by the NRF, the synthetic monitoring request messages to NF service instances registered with the NRF;
receiving, by the NRF and from the NF service instances, responses to the synthetic monitoring request messages;
analyzing, by the NRF, contents of the responses to the synthetic monitoring request messages;
maintaining, by the NRF and based on the contents of the responses to the synthetic monitoring request messages, indications of working status of the NF service instances;
receiving, by the NRF, an NF discovery request message; and
generating, by the NRF and using the indications of working status of the NF service instances, an NF discovery response message.
